(19) United States
(12) Patent Application Publication
(10) Pub. No.: US 2025/0392222 A1
(43) Pub. Date: Dec. 25, 2025

(54) EFFICIENCY MODE FOR A MULTIPHASE VOLTAGE REGULATOR

(71) Applicant: Advanced Micro Devices, Inc., Santa Clara, CA (US)

(72) Inventors: Wei HAN, Shanghai (CN); Lili CHEN, Shanghai (CN)

(21) Appl. No.: 18/748,058

(22) Filed: Jun. 19, 2024

(51) Int. Cl. H02M 3/158; H02M 1/00; H02M 3/157

(52) U.S. Cl. CPC H02M 3/1586; H02M 1/0025; H02M 3/157

(57) ABSTRACT

Embodiments herein describe a voltage regulator with at least one power stage (or phase) that includes circuitry for providing an efficiency mode for low power situations. For example, when an output voltage and current of the power stage is below a threshold, the voltage regulator can switch to the efficiency mode (e.g., a high efficiency mode (HEM)). When in the efficiency mode, the power stage can use a first, lower input voltage to perform pulse width modulation (PWM). However, when in a high power mode, the power stage can use a second, higher input voltage to PWM. For example, the power stage can include one or more switches for switching between the first and second input voltages to use in the different modes of operation.

### TECHNICAL FIELD

Examples of the present disclosure generally relate to a low power mode of a voltage regulator.

### BACKGROUND

Typically, an electrical chipset defines the voltage/current requirements in its specification. A step-down or a step-up voltage regulator is often used to supply power to the chipset. Therefore, the efficiency of the voltage regulator will impact the system performance, especially as the amount of voltage/current of the required by the chipset changes. For example, a silicon integrated circuit (IC) typically has a voltage range from 0.6V˜1.5V. When the circuitry in the IC is performing compute intensive tasks, it may require 1.5V voltage, which means current is high also. However, other tasks may require only 0.6V such as when the computing system is in idle or running less-compute intensive tasks. Using different modes of operation of the voltage regulator when the IC has different power draws can improve efficiency, which can improve the battery life of a mobile computing device.

A multiphase voltage regulator is often used to supply high power to such electronic devices. Generally, the multi-phase controller allows the switching regulator to seamlessly switch from continuous current mode (CCM) to discontinuous current mode/pulse frequency modulation (DCM/PFM) operation. However, light load efficiency of the switching regulator is limited due to the large power components in current multiphase voltage regulators.

### SUMMARY

One embodiment described herein is a voltage regulator that includes a pulse width modulation (PWM) controller and a power stage configured to receive a PWM signal from the PWM controller in order to step-down an input voltage, wherein the power stage includes at least one switch for changing the input voltage from a higher voltage value to a lower voltage value used when performing PWM using the PWM signal.

One embodiment described herein is an integrated circuit that includes a voltage regulator which includes a power stage and a pulse width modulation (PWM) controller configured to switch between a first mode where the power stage uses a first input voltage to perform PWM and a second mode where the power stage uses a second, different input voltage to perform PWM.

One embodiment described herein is a method that includes monitoring an output of a power stage in a voltage regulator, in response to the output of the power stage falling below a threshold, enabling a first mode where the power stage uses a first input voltage to perform PWM, and in response to the output of the power stage being above the threshold, enabling a second mode where the power stage uses a second input voltage to perform PWM.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a multiphase voltage regulator, according to an example.

FIG. 2 illustrates a power stage with a high efficiency mode for low power situations, according to an example.

FIG. 3 is a flowchart for switching a voltage regulator into a high efficiency mode for low power situations, according to an example.

FIG. 4 is a flowchart for switching a voltage regulator into a high efficiency mode for low power situations, according to an example.

FIG. 5 illustrates charts corresponding to the operations described in FIG. 4, according to an example.

FIG. 6 is a block diagram of a computing system, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe a multiphase voltage regulator with at least one Power Stage (or SPS phase) that includes circuitry for providing a high efficiency mode for low power situations. For example, when an output voltage and current of the power stage is below a threshold, the voltage regulator can switch from CCM to the high efficiency mode (HEM). In one embodiment, when in CCM, the power stage uses a first supply voltage (e.g., a higher voltage value of 10V), but when in HEM, the power stage switches to using a second, lower supply voltage (e.g., a lower voltage value of 5V). In addition, the voltage regulator can adjust the duty cycle of pulse width modulation (PWM) to provide the same output voltage in the HEM as the CCM but using a lower supply voltage. Using the HEM improves efficiency relative to using the traditional DCM/PFM in low power situations. Moreover, the embodiments herein can advantageously use circuitry within the power stage of the voltage regulator to enable the HEM, rather than having separate circuitry in the voltage regulator that is used during low power situations.

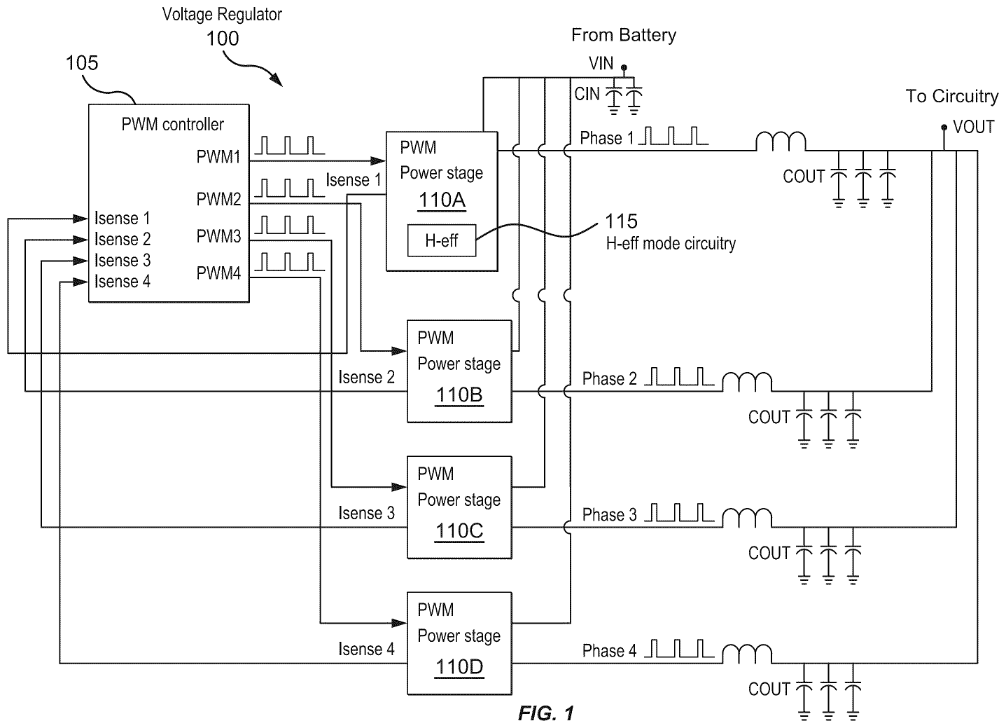

FIG. 1 illustrates a multiphase voltage regulator 100, according to an example. The voltage regulator 100 includes a PWM controller 105 and four power stages 110, which each corresponds to a different phase. Thus, in this example, FIG. 1 illustrates a four-phase voltage regulator 100. However, this is just one example and voltage regulators with fewer, or more, voltage regulators and phases can be benefit from the embodiments described herein.

In performance mode (where the downstream circuitry draws substantial current and uses a high voltage (e.g., 1.5V)), the voltage regulator 100 ensures the voltage drop is under expectation. To provide the most current, the voltage regulator 100 uses each of the four power stages in CCM. As shown, the PWM controller 105 can output four PWM signals (i.e., PWM1-4) which are provided to the power stages 110A. The duty cycle of the PWM signals control how much power is output by each of the power stages 110.

The PWM controller 105 can adapt to the current draw of the circuitry being powered by Vout. The PWM controller 105 receives current sense signals from the power stages 110 (i.e., Isense1-4) which are a measure of the current being supplied by the power stages 110 to Vout (i.e., the downstream circuitry). As the measured current increases, the PWM controller may increase the number of power stages being used. For example, for low power situations, the voltage regulator 100 may use only the power stage 110A to provide power to Vout while the power stages 110B-D are not used (i.e., PWM1 is provided to the power stage 110A but PWM2-4 are not provided to power stages 110B-D). However, as the measured current increases, the PWM controller may use both power stages 110A and 110B by suppling PWM1 and PWM2 to those stages. As the measured current continues to increase, the PWM controller may use power stages 110A-C to power Vout, and so forth. These can be referred to as 1-phase CCM where only power stage 110A is used, 2-phase CCM where power stages 110A-B are used, 3-phase CCM where power stages 110A-C are used, and 4-phase CCM where power stages 110A-D are used.

In addition to CCMs, the voltage regulator 100 supports HEM for light loading (e.g., low power conditions). In addition to using the measured current (and measured voltage) to switch between the different CCMs, the measured current/voltage can be used to switch from CCM (e.g., from 1-phase CCM) to HEM. To do so, the power stage 110A includes HEM circuitry 115 which switches the power stage 110A from CCM to the HEM. As discussed in more detail in the Figures below, when in HEM, the power stage 110A uses a lower input voltage (VIN) than when in one of the CCMs.

In one embodiment, VIN is provided by a battery, but the embodiments herein are not limited to a battery and can be used with a constant (e.g., grid) power supply. VIN is provided to each of the power stages 110A-D which is then stepped down using the PWM1-4 signals. However, instead of using the VIN for CCM, the HEM circuitry 115 provides a lower VIN to the power stage 110A—e.g., 5V instead of 10V. Using a lower VIN results in increased efficiency in the voltage regulator versus using DCM which uses the same VIN as CCM.

While FIG. 1 illustrates the HEM circuitry 115 in one of the power stages 110A, in other embodiments, the HEM circuitry 115 may be placed in multiple ones of the power stages 110 so that these power stages can also be active in the HEM, if desired.

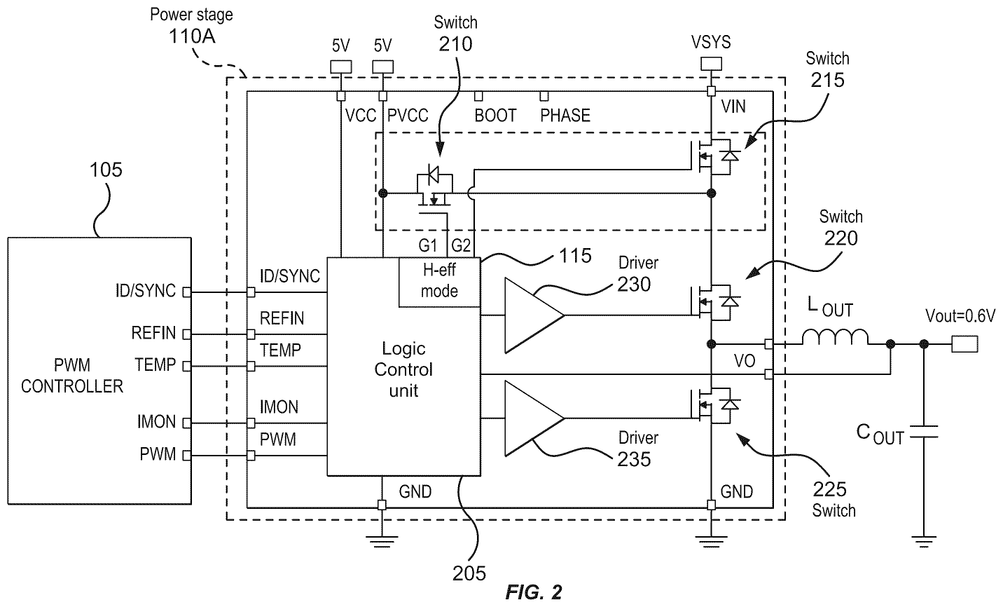

FIG. 2 illustrates the power stage 110A with a HEM for low power situations, according to an example. Like in FIG. 1, the power stage 110A is controlled by the PWM controller 105. The PWM controller 105 includes an ID/SYNC signal used as low power mode control to activate the HEM in the power stage 110A. The REFIN signal and below TEMP are option signals, that could also be replaced by other indicators. The TEMP signal is used by the power stage 110A to report its temperature to the PWM controller 105. The IMON signal indicates the output current the power stage provides at VOUT to the downstream circuitry (e.g., Isense1 in FIG. 1). The PWM signal is the PWM scheme used to step-down the input voltage, which is shown as PWM1 in FIG. 1.

The power stage 110A includes logic control unit 205 and HEM circuitry 115 that contain logic for switching the power stage 110 from CCM to HEM in response to instructions received from the PWM controller 105. As shown, the HEM circuitry 115 is connected to switches 210 and 215 for switching between an input voltage used in during CCMs (i.e., VSYS, such as 10V) and an input voltage used in HEM (i.e., PVCC, such as 5V). That is, the HEM circuitry 115 uses gate signals G1 and G2 to turn on and off the switches 210 and 215. When in one of the CCMs, the HEM circuitry 115 can turn off switch 210 and turn on switch 215. When in HEM, the HEM circuitry 115 turns off switch 215 and turns on switch 210.

Depending on which of the switches 210, 215 is on determines the voltage seen at the source of a switch 220 (referred to as the high-side switch). When in CCM, the switch 220 receives VSYS (e.g., 10V) as the input voltage, but when in HEM, the switch 220 receives PVCC.

The logic control unit 205 can use the received PWM from the PWM controller 105 to provide PWM signals to the drivers 230 and 235 which control the gates of the switches 220 and 225, respectively. By turning on and off the switches 220 and 225 using the PWM signals (along with the inductor LOUT and capacitor COUT), a stepped-down voltage is provided at VOUT (e.g., 0.6V in HEM).

In one embodiment, the PWM signals used in the CCM(s) are different from the PWM signals used in HEM. For example, because HEM uses a lower input voltage, the duty cycle of the PWM signals used in HEM may be increased relative to the duty cycle of the PWM signals used in a low power CCM. Doing so can ensure the power stage 110A provides a similar output voltage VOUT for low power operation as if CCM was being used.

In FIG. 2, the switches 210, 215, 220, and 225 are shown as being transistors (NMOS transistors). The embodiments herein are not limited to any particular type of transistor, as the implementation may varying depending on the platform in which the voltage regulator is implemented. The embodiments herein can be used with any suitable switching element that permits the input voltage to be changed in response to switching to a low power mode of operation (e.g., HEM).

In one embodiment, VSYS is provided by a battery, but could be provided instead by a constant power supply (e.g., an electrical grid and an AC-DC adapter). Moreover, the PVCC signal used during HEM may be provided by the same supply that provides VSYS or a different power supply. The embodiments herein are not limited to any particular technique for providing different input voltages for supporting a voltage regulator that can switch from one or more CCMs to a HEM.

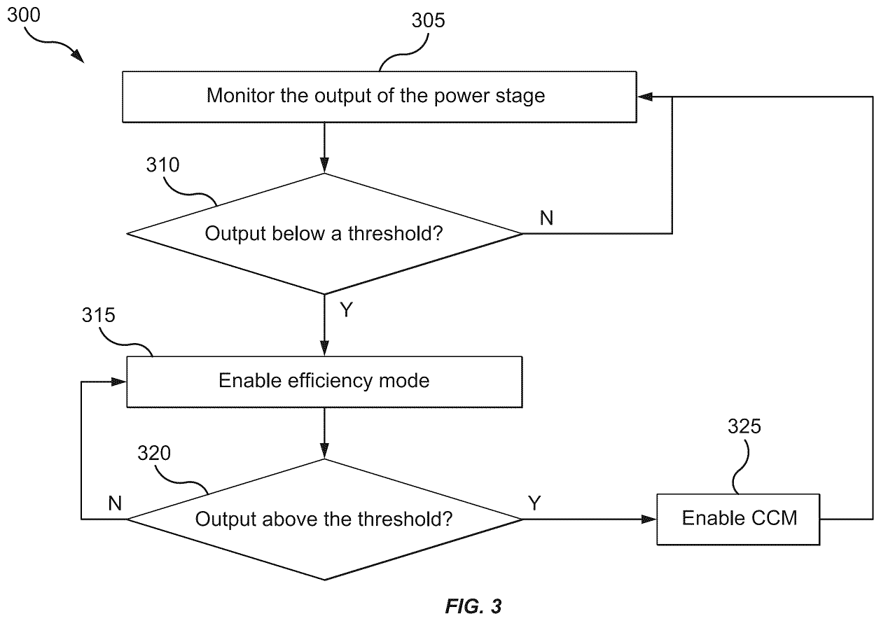

FIG. 3 is a flowchart of a method 300 for switching a voltage regulator into a HEM for low power situations, according to an example. At block 305, the PWM controller in the voltage regulator (e.g., the PWM controller 105 in FIGS. 1 and 2) monitors the output of the power stage (e.g., the power stage 110A in FIGS. 1 and 2 which includes HEM circuitry 115). In one embodiment, the PWM controller monitors the output current, the output voltage, or both, of the power stage. In one embodiment, the PWM controller monitors the output power of the power stage.

In one embodiment, the output of the power stage (or phase) is determined by an operation mode of the downstream circuitry that is powered by the voltage regulator. If the downstream circuitry is in a high-performance mode, the circuitry may draw more current from the power stage and use a higher voltage (e.g., 1.5V). In contrast, when the downstream circuitry is idle or performing a task that is not compute intensive, the circuitry may draw less power and use a lower voltage (e.g., 0.6V). The PWM controller can measure the output of the power stage to infer the operational mode of the downstream circuitry.

At block 310, the PWM controller determines whether the output of the power stage is below a threshold. The threshold can indicate when the downstream circuitry has entered into a low-performance mode and the voltage regulator should use HEM to power the circuitry.

If the output of the power stage is not below the threshold, the method 300 returns to block 305 where the voltage regulator continues to use the current mode, for example, CCM. However, if the output is below the threshold (e.g., the output satisfies the threshold), the method 300 proceeds to block 315 where the voltage regulator enables the efficiency mode (e.g., HEM). In one embodiment, the voltage regulator switches from CCM to HEM.

In one embodiment, the power stage using a lower input voltage supply when in the efficiency mode than the mode used when the output is above the threshold (e.g., CCM). Moreover, the PWM controller may use different PWM signals to drive the power stage in the efficiency mode than the mode used when the output is above the threshold. For example, the PWM signals used in the efficiency mode may have a longer duty cycle to compensate for using a lower input voltage.

At block 320, the PWM controller continues to monitor the output of the power stage to determine whether it changes to being above the threshold. So long as the output remains below the threshold, the method 300 maintains the efficiency mode at block 325. However, if the output of the power stage changes to being above the threshold, the method 300 proceeds to block 325 where it enables CCM. That is, the voltage regulator switches from the efficiency mode (e.g., HEM) to CCM.

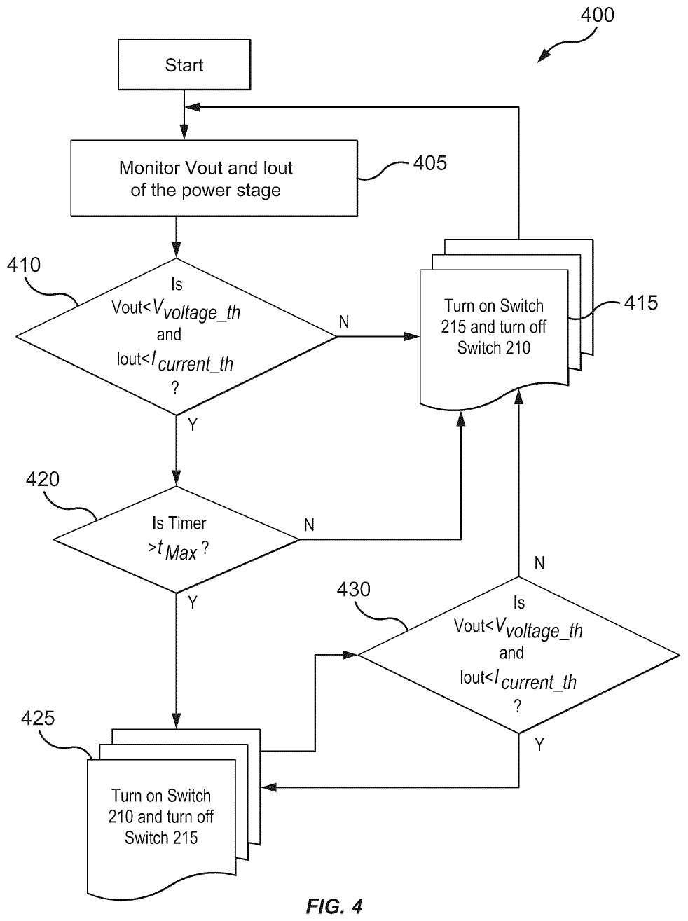

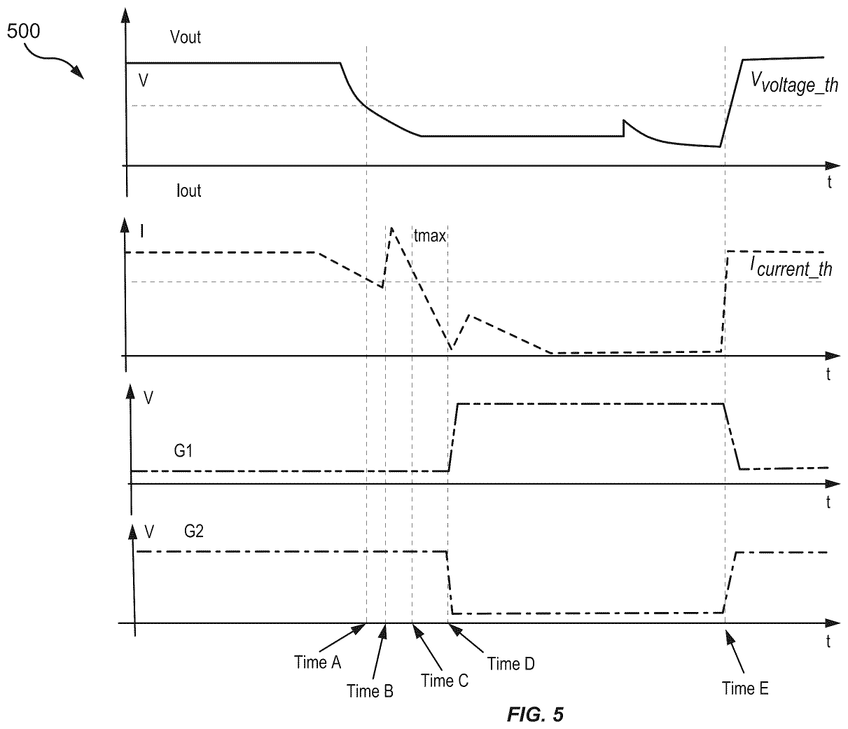

FIG. 4 is a flowchart of a method 400 for switching a voltage regulator into a HEM for low power situations, according to an example. For ease of explanation, the blocks of method 400 are discussed in tandem with FIG. 5 which illustrates charts corresponding to the operations described in FIG. 4.

At block 405, the PWM controller monitors the output voltage (Vout) and output current (Iout) of the power stage.

At block 410, the PWM controller determines whether both Vout and Iout are below respective voltage and current thresholds V_{voltage_th} and I_{current_th}. If one or both of Vout and Iout are not below the thresholds, the method 400 proceeds to block 415 where the PWM controller instructs the HEM circuitry in the power stage to turn on switch 215 in FIG. 2 and turn off switch 210. This provides the higher input voltage VSYS to the switch 220.

In FIG. 5, the duration before Time A illustrates when Vout and Iout are above the respective thresholds V_{voltage_th} and I_{current_th}. As such, G1 in FIG. 2 is low which turns off switch 210 and G2 is high which turns on switch 215 so that VSYS is provided to switch 220.

However, immediately after Time A, Vout and Iout both cross the thresholds V_{voltage_th} and I_{current_th}. In that case, the PWM controller starts a timer to measure how long both Vout and Iout remain below the thresholds V_{voltage_th} and I_{current_th}. That is, the PWM controller can continually (or at intervals) determine whether Vout and Iout remain below the thresholds V_{voltage_th} and I_{current_th}. If so, the timer continues to run. However, if one of Vout or Iout is no longer below their respective thresholds, the PWM controller stops the timer. For example, Time B illustrates that Iout is now at (or above) the threshold I_{current_th}. In that case, the PWM controller resets the timer.

At Time C, Iout is again below the threshold I_{current_th}. Because Iout and Vout are again below their respective thresholds, the PWM controller restarts the timer.

At block 420, the PWM controller determines whether the timer is at a maximum (t_{MAX}). If not, the method 400 returns to block 415 where the PWM controller keeps switch 215 turned on and switch 210 turned off. At block 405, the PWM controller continues to monitor Vout and Iout to ensure they remain below the thresholds V_{voltage_th} and I_{current_th}.

However, if the timer reaches the maximum, the method 400 proceeds to block 425 where the PWM controller turns on switch 210 and turns off switch 215. This is shown at Time D of FIG. 5 where the timer reaches the maximum value t_{MAX} (e.g., a predefined time period). in response, the PWM controller instructs the power stage to use G1 to turn on the switch 210 and use G2 to turn off the switch 215. As such, a lower input voltage is provided to the switch 220 to use when performing PWM.

At block 430, the PWM controller continues to monitor Vout and Iout to ensure they both remain below their respective thresholds. If so, the method 400 returns to block 425 where the switch 210 remains on and the switch 215 remains off (e.g., the voltage regulator stays in the HEM).

However, if one or both of Vout and Iout are at or above their respective thresholds, the method 400 proceeds to block 415 where the switch 215 is turned on and the switch 210 is turned off, thereby switching the voltage regulator back to the higher power mode (e.g., CCM). For example, at Time E in FIG. 5 Iout exceeds the threshold I_{current_th}, and in response the PWM controller instructs the power stage to use G1 to turn off the switch 210 and use G2 to turn on the switch 215. As such, the higher input voltage VSYS is supplied to the switch 220 to perform PWM.

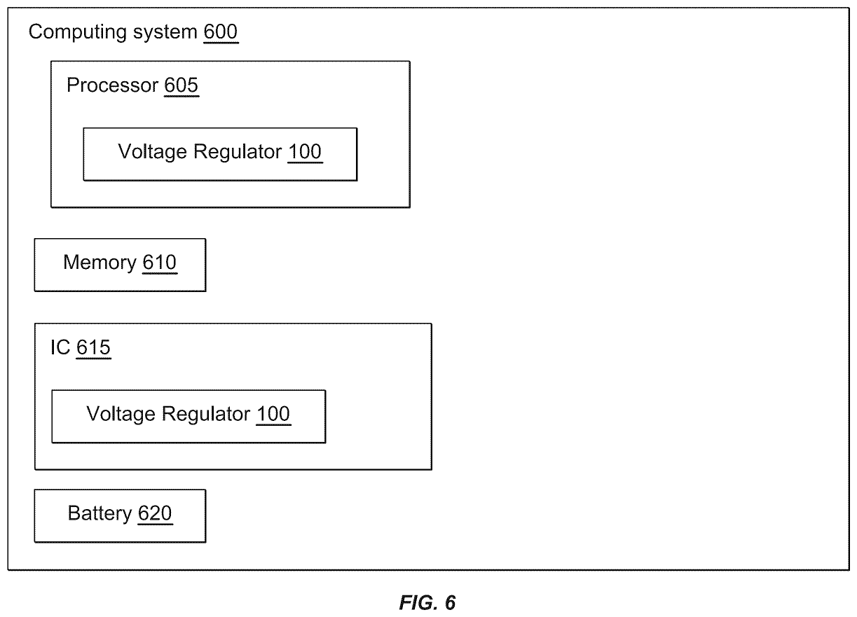

FIG. 6 is a block diagram of a computing system 600, according to an example. The computing system 600 can be a single computing device or a collection of computing devices. For example, the computing system 600 can be a smartphone, tablet, laptop, desktop, server, and the like. Alternatively, the computing system 600 can be servers or a cluster of compute resources in a data center or a cloud computing environment. These servers or this cluster can be communicatively coupled with one or more switches (e.g., a network).

The computing system 600 includes a processor 605, memory 610, an IC 615, and a battery 620. The processor 605 can represent any number of processors that each can contain any number of processor cores. For example, the processor 605 can be a central processing unit (CPU) for the computing system. As shown, the processor 605 includes the voltage regulator 100 discussed above which can include at least one power stage with HEM circuitry which enables an efficiency mode for low power operation. In one embodiment, this efficiency mode can use a different input voltage relative to a performance mode of the voltage regulator 100 used for high power operation.

The memory 610 can include volatile memory elements, non-volatile memory elements, and combinations thereof.

The IC 615 can be a graphics processing unit (GPU), a hardware accelerator, or an accelerator processing unit (APU). For example, the IC 615 can be an application specific IC (ASIC), a system on a chip (SoC), a field programmable gate array (FPGA), and the like. Like the processor 605, the IC 615 includes the voltage regulator 100 described in the embodiments above. Thus, multiple different types of chips can use the voltage regulator 100 to provide power to circuitry within the chips.

The battery 620 can provide input power to the voltage regulator 100 which then step down the voltage to a voltage that is suitable for the circuitry in the processor 605 and the IC 615. The battery 620 may be optional. For example, the computing system 600 may be a portable or handheld computing device. However, if the computing system 600 is stationary, the battery 620 may be omitted since the computing system 600 can be plugged into an electrical grid. In any case, the computing system 600 can still benefit from the power savings offered by using the voltage regulator 100.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A voltage regulator, comprising:
a pulse width modulation (PWM) controller; and
a power stage configured to receive a PWM signal from the PWM controller in order to step-down an input voltage, wherein the power stage includes at least one switch for changing the input voltage from a higher voltage value to a lower voltage value used when performing PWM using the PWM signal.

2. The voltage regulator of claim 1, wherein the at least one switch comprises a first switch coupled to a first input voltage that provides the higher voltage value and a second switch coupled to a second input voltage that provides the lower voltage value.

3. The voltage regulator of claim 2, wherein the power stage further comprises:
a third switch coupled to both the first and second switches, wherein the third switch is controlled based on the PWM signal to perform PWM using one of the lower voltage value or the higher voltage value.

4. The voltage regulator of claim 1, wherein the PWM controller is configured to monitor at least one of an output current or an output voltage of the power stage to determine when to switch to a first mode where the higher voltage value is used to perform PWM and a second mode where the lower voltage value is used to perform PWM.

5. The voltage regulator of claim 4, wherein the first mode is a continuous current mode (CCM), wherein a different duty cycle is used to perform PWM in the first mode than in the second mode.

6. The voltage regulator of claim 5, further comprising:
a second power stage, wherein the higher voltage value or a higher current value is used to perform PWM in both the second power stage and the power stage in a 2-phase CCM, wherein the first mode is a 1-phase CCM where the higher voltage value is used to perform PWM in the power stage but not in the second power stage.

7. The voltage regulator of claim 4, wherein the PWM controller is configured to switch to the second mode only after the output current and the output voltage of the power stage have both been below respective thresholds for a predefined time period.

8. An integrated circuit (IC), comprising:
a voltage regulator comprising:
a power stage; and
a pulse width modulation (PWM) controller configured to switch between a first mode where the power stage uses a first input voltage to perform PWM and a second mode where the power stage uses a second, different input voltage to perform PWM.

9. The IC of claim 8, wherein the power stage comprises a first switch coupled to the first input voltage and a second switch coupled to the second, different input voltage.

10. The IC of claim 9, wherein the power stage further comprises:
a third switch coupled to both the first and second switches, wherein the third switch is controlled based on a PWM signal received from the PWM controller to perform PWM using one of the first input voltage or the second, different input voltage.

11. The IC of claim 8, wherein the PWM controller is configured to monitor at least one of an output current or an output voltage of the power stage to determine when to switch to the first mode and the second mode.

12. The IC of claim 11, wherein the first mode is a CCM, wherein a different duty cycle is used to perform PWM in the first mode than in the second mode.

13. The IC of claim 12, wherein the voltage regulator further comprises:
a second power stage, wherein the first input voltage is used to perform PWM in both the second power stage and the power stage when in a 2-phase CCM, wherein the first mode is a 1-phase CCM where the first input voltage is used to perform PWM in the power stage but not in the second power stage.

14. The IC of claim 11, wherein the PWM controller is configured to switch to the second mode only after the output current and the output voltage of the power stage have both been below respective thresholds for a predefined time period.

15. A method comprising:
monitoring an output of a power stage in a voltage regulator;
in response to the output of the power stage falling below a threshold, enabling a first mode where the power stage uses a first input voltage to perform PWM; and
in response to the output of the power stage being above the threshold, enabling a second mode where the power stage uses a second input voltage to perform PWM.

16. The method of claim 15, wherein monitoring the output of the power stage comprises monitoring both an output current and an output voltage of the power stage to determine whether the output current and the output voltage are below respective thresholds.

17. The method of claim 16, wherein the first mode is enabled only when the output current and the output voltage are both below the respective thresholds.

18. The method of claim 17, wherein the first mode is enabled only when the output current and the output voltage are both below the respective thresholds for a predefined period of time, wherein the second mode is enabled when either of the output current or the output voltage is above the respective thresholds.

19. The method of claim 15, wherein enabling the first mode comprises:
turning on a first switch to couple the first input voltage to a second switch that performs PWM; and
turning off a third switch coupled to the second input voltage.

20. The method of claim 19, wherein enabling the second mode comprises:
turning on the third switch to couple the second input voltage to the second switch that performs PWM; and
turning off the first switch coupled to the first input voltage.
